(19) United States
(12) Patent Application Publication
(10) Pub. No.: US 2004/0133480 A1
(43) Pub. Date: Jul. 8, 2004

(54) Targeted promotional method & system

(76) Inventor: Ronald J. Domes, Calgary (CA)

Correspondence Address: GOWLING LAFLEUR HENDERSON, Suite 2600, 160 Elgin Street, Ottawa, ON, K1P 1C3, CA

(21) Appl. No.: 10/670,756

(22) Filed: Sep. 26, 2003

Related U.S. Application Data
(60) Provisional application No. 60/413,550, filed on Sep. 26, 2002.

(51) Int. Cl. G06F 17/60

(52) U.S. Cl. 705/26

(57) ABSTRACT

The present invention relates generally to a method and system for advertising or otherwise promoting goods and services, and more particularly to the highly targeted delivery of promotional content based on audience characteristics including: venue, date, day, time—and the content of which promotion is dynamically reconfigurable by an initiating promoter. The system and method develop venue and content demographics that are then used to determine appropriate promotional targeting.

### FIELD OF THE INVENTION

The present invention relates generally to a method and system for promoting goods and services, and more particularly to the highly targeted delivery of content

### BACKGROUND OF THE INVENTION

The concept of a method of and a system for implementing such method of advertising and otherwise promoting goods and services only to those audiences most likely to purchase the subject matter of the promotion is well known. Local television, billboards, flyers and the like are often located or placed according to who is expected to travel through or be at a particular location or to view or record a particular billboard or flyer. However, the tracking of and delivery to such audiences is an ongoing problem for all promoters. Even where the characteristics of the consumers of a particular good or service are well understood, in order to increase the effectiveness of promotional expenses it is necessary to have periodic feedback confirming the location of such audience and the means by which to deliver promotional content to those locations in a timely manner. Conventional methods for promotion at best pay lip service to the need to gather consumption data, analyse it and integrate what is learned rapidly into the next round of marketing investment. The systems currently available to implement those methods that do recognize the importance of integrating feedback simply cannot respond in a sufficiently timely manner. Other systems offer detailed feedback, however in a very time delayed manner such that said time delay prohibits rapid response to market demand.

More recent computing device based methods and systems of promotion include U.S. Pat. No. 6,390,376 to Bermel (‘376’) teaches a “method and apparatus for providing targeted advertising in public areas” according to which a display device has been adapted to present advertising targeted to persons in the vicinity of the display device using a controller that communicates with at least one of a plurality of electronic cards in the possession of persons in the vicinity of the display device. Each electronic card stores information regarding the person associated with that card. A communicator receives signals from the cards in the vicinity of the display device then communicates with a central computer that selects and communicates advertising based on information stored about the person. Clearly the system relies upon extensive disbursement of the cards to effect targeting.

U.S. Pat. No. 6,332,127 to Bandera (‘127’) teaches “systems, methods and programs for providing time and location specific advertising via the internet”, which addresses the need to change content within an object displayed within a Web page based on changes in geographic location of a user. However, 127 fails to address the vast majority of promotion, which is not on the InterNet. Requires access to Internet, so not readily adoptable to potentially large transient audiences, such as those in airports, large shopping malls, train stations and other public gathering places.

U.S. Pat. No. 6,286,005 to Cannon (‘005’) teaches a “method and apparatus for analyzing data and advertising optimization” according to which a computer-based decision support system including: a database mining engine (DME); an advertising optimization mechanism; and a customized user interface that provides access to the various features of the invention—together store, retrieve and manipulate data from existing databases containing media-related audience access data describing the access habits and preferences of the audience for the purpose of optimization permitting businesses, networks, and advertising agencies to interactively create, score, rank and compare various proposed or actual advertising strategies in a simple and efficient manner. The invention of 005 is directed to reduced processing time during the analysis of the data gathered rather than to the use of such results in the more refined promotion of goods and services to a targeted audience.

None of the prior art reviewed teaches anything regarding the association (positive or negative) of promotional content with secure content.

### SUMMARY OF THE INVENTION

In order to overcome the disadvantages of the prior art being “broadcast” in nature, which form of market coverage is inherently unfocussed and wasteful of marketing resources, in a preferred embodiment the method of the present invention uses means to identify the audience of patrons in attendance at each venue of installation and then by tracking consumption patterns and analyzing for relationships in the context of a wide range of factors continually improve the “Rule Set” by which it promotional content is selected for presentation to the expected and actual audience. As participating promoters enjoy the higher conversion rates of the highly targeted delivery, they learn along with the system and become better able to reconfigure their promotional content, which is possible even in a dynamic manner to convert time limited opportunities into sales.

There is no known no means by which an advertiser or promoter can conveniently deliver promotional content to a plurality of display devices in a selective and discriminatory manner independent (optionally matching secure content with promotional content) of non-promotional content delivered via the system. There is currently no entertainment or educational system that allows location specific and time dependent presentation of promotional content. Conventional mechanisms include television and radio, print media (inc. Newspapers), and direct mail.

The present invention relates generally to a method and system for advertising or otherwise promoting goods and services, and more particularly to the highly targeted delivery of promotional content that is dynamically reconfigurable by an initiating promoter. The several advantages of a lower cost per opportunity converted result from the presentation of promotional content through a plurality of client devices only at locations and times specified by a central controlling server and the promotional content is uniquely defined per client device.

The method aspect of present invention includes a series of steps that include the identification of the subject audience, an attempt to match the promotion to both the audience and the secure content that the consumer-users of that audience are actually then paying to hear, and the tracking of results from which the system and its operators can learn to refine the promotional content, its arrangement, and the secure content with which to associate it.

Consequently, the promotional content can be changed rapidly and the desired target audience can be expanded, contracted or redefined with a level of granularity not currently available in other forms of media or methods of presentation.

The system aspect of the present invention deploys an apparatus that is so flexible and versatile that initiating promoters can use it in various modes (e.g. self-promotion and cross-selling or joint marketing) and even bid to obtain the best time slots for a particular good or service in a particular venue—by “queue jumping” upon the payment of an acceleration fee. Unlike other forms of media, both promoters and consumer-users can pay to queue jump at the last minute before a critical date, making the system potentially lucrative for operators and venue owners.

In order to overcome the disadvantages of the prior art being wastefully unfocussed according to one aspect of the invention, in one of its broad embodiments, there is provided a method of targeted promotion to an audience using at least one centrally controlled audio-video apparatus having audience ranking data comprising the steps of: determining a desired audience for a given promotion; selecting promotional content based on the desired audience; selecting at least one audio-video apparatus in dependence upon audience ranking data; and transmitting instructions to the at least one audio-video apparatus for effecting presentation of the selected promotional content to a desired audience.

Consequently the step of determining a desired audience for the subject promotion includes consideration of one or more factors selected from the group of: date, day of week, time of day, location, venue class, and statistical consumption pattern for subject venue.

In a preferred embodiment of the present invention promotional content is presented (in addition to or) interspersed with secure content and the selection of promotional content further comprises consideration of one or more factors selected from the group of: secure content presented concurrently, pending user selections of secure content, recent presentations or promotional content, maximum presentations permitted per unit time, desired blends (tempos), absolute bars respecting association, compatible artists and preferred associations, pre-existing consent or permitted association license grants, queue jumping or priority play acceleration fees paid by initiating promoter, initiating promoter preferred time slot bidding results, venue and network operator promotions, and initiating promoter account status. It may be desirable to pre-classify the promotional content for the purpose of facilitating matching, for example with reference to an external classification resource. The pre-classification of secure content for the purpose of matching same with promotional content to be associated therewith is also part of a preferred embodiment.

According to a further broad embodiment of the method aspect of the present invention it is desirable to refine the selection of promotional content based on data respecting the presence of specific current patrons or of the cross-section (averaged) of a class of patrons in the subject venue. This may be accomplished by connecting to the venue's pre-existing systems for recording patron traffic (if any are in place) or by permitting consumer-users to access said apparatus by alternative input means including, but not limited to, physical touch screen interface, voice commands, wireless hand held devices, PDAs, SmartCards for the purposes of selection and payment—in the course of which access promotional incentives are delivered and the preferences of said consumer-users are tracked in more detail. The method of the present invention contemplates permitting purchases to be made by consumer-users through the audio-video apparatus aspect of the present as well as tracking purchases for the purpose of detecting (or identifying) and cross-tracking consumption patterns. In a preferred embodiment of the invented method the operator determines and tracks the conversion rate achieved by presenting each said promotional content to sales and feeding back the results for the purpose of supporting the evolutionary behaviour of said system permitting the refinement of the “association rules” that govern which secure content to associate each promotional content with for the purpose of improving the conversion rate, including but not limited to free plays of “clips” of secure content during “idle” mode when said apparatus awaits instructions from consumer-users making selections.

According to a further broad embodiment of the method aspect of the present invention the operator will provide access by external parties, including but not limited to initiating promoters, to an inventory of promotional content that has been created, converted, or otherwise supplied and uploaded to a source for the purposes of being altered externally and being used to alter the promotional content stored on or presented through said audio-video apparatus. In a further preferred embodiment the operator also provides access by external parties, including but not limited to initiating promoters, to inject promotional content on short notice to a current presentation by said audio-video apparatus for the purpose of enhancing or supplementing at least one scheduled promotional presentation.

According to a preferred embodiment of the apparatus aspect of the present invention there is provided a digital video entertainment device having: storage and retrieval means for handling data representing promotional content associated with audience ranking data; storage and retrieval means for handling data representing secure content; interface means for accepting and responding to user selections respecting secure content; at least one presentation means having elements that are visible or audible to said audience; means for preventing the presentation of specified promotional content during the presentation of specified secure content; means for receiving instructions; means for presenting promotional content; means for matching said desired audience to said audience ranking data; means for selecting promotional content based on determination of a desired audience; means for tracking said user selections for the purpose of refining said audience ranking data; means for the local tracking, processing and archiving of system usage and presentations made, for the purpose of developing a database useful in detecting consumption patterns in addition to accounting functions; means for the transfer of promotional content (and reporting data) between said apparatus and at least one controller or server; means for the instant reconfigurability of promotional content having override codes permitting an external party to inject promotional content on short notice to a current presentation by said apparatus for the purpose of enhancing or supplementing at least one scheduled promotional presentation; means for permitting consumer-users to access said apparatus by alternative input means including, but not limited to, physical touch screen interface, voice commands, PDAs, other wireless hand held devices, SmartCards for the purposes of selection and payment; together with encryption or other secure means for the transfer of secure content into said apparatus or from said apparatus to external devices or media for distribution in isolation or as part of a compilation. The tracking of consumer-user behaviour is implemented using “bubbles” (snapshots over a block of time rather than at a point in time) or instances of a series of views of the features and content available at the subject installation, which viewing information represent the activities of a particular (potentially anonymous) consumer during a session. Browsing (tire kicking) activity is weighted differently from activity recorded in a bubble associated with an actual purchase. Associations observed during a non-browsing or buying session will be accorded an “upgraded” status for tracking and storage purposes.

Conveniently, embodiments of the present invention included means for gathering information into clumps or bubbles such that elements of the information are closely associated with each other, without restricting the elements of the information to said bubbles. For example if a person selects artist A then artist B, that relationship is very valuable if that relationship is found in many users. The fact that artist A was selected (even if only their information was viewed) before B can be an important element. Conveniently, systems that record the fact that artist A was selected X times and artist B was selected Y times would typically miss the very valuable relationship that our system can identify.

According to a preferred embodiment of the centrally controlled system aspect of the present invention there is provided for the use of an initiating promoter wishing to present promotional content to a desired audience respecting which audience said promoter has determination data, comprising: at least one source of promotional content; means for said initiating promoter to supply desired audience determination data; means for selecting promotional content based on matching in light of said determination data; at least one audio-video apparatus, having audience ranking data, for presenting promotional content to said desired audience; and Controller means for transmitting instructions to said audio-video apparatus, together with Server means for transferring said promotional content to said audio-video apparatus for the purpose of causing said selected promotional content to be presented to at least one audience.

According to a preferred embodiment of the centrally controlled system aspect of the present invention there is provided means to store and retrieve promotional content onboard said audio-video apparatus; means to securely store and retrieve secure content onboard said audio-video apparatus; means for an initiating promoter to supply or reconfigure said promotional content by substitution or supplementation; means to accept payment from consumer-users, for the selection of secure content to be presented, or for the purchase of goods and services (based on said promotional content) using an interface to said audio-video apparatus; and means to track the presentation of promotional content or secure content for accounting and statistical purposes.

The method, system and apparatus of the present invention are well suited to application in a wide variety of venues. It is contemplated that the apparatus of the present invention could be installed in: entertainment venues (including but not limited to bars, pubs, and restaurants), hotels (in lobbies or in rooms), waiting rooms (medical, dental, or government offices), airports and the like.

Advantageously, the present invention does not require the users of the environment to carry any device nor communicate any personal information to the system for the system to be able to effectively communicate the appropriate advertising. Preferably, advertising information is determined by calculating the demographics from a combination of a) the types of music and entertainment materials selected by the community of patrons of the establishment, b) demographic information of area or region of the establishment that the device resides in, c) the types of music and entertainment materials selected by the management of the establishment as the offering within said establishment, d) the types of music and entertainment materials presented in surrounding areas with similar locations offering similar materials and clientel, and e) the cross-section and cross-compilation of all of the aforementioned items. As people tend to coalesce with similar people, the present method provides a method to reach people that do not interact with the system in any fashion, providing a means to target these people with advertising and promotions. Unlike television and radio, the resolution of the advertising target is very small, often the size of a typical restaurant or bar.

Embodiments of the present invention are targeted towards commercial establishments where the patrons are being entertained with a combination of music and/or video, and neither uses web pages, changes the content specific to a single user, nor is related to the internet or the internet style of presenting information to the user interacting with it.

### BRIEF DESCRIPTION OF THE DRAWINGS

The present invention, in order to be easily understood and practised, is set out in the following non-limiting examples shown in the accompanying drawings, in which:

FIG. 1 is an illustration of one embodiment of the targeted promotion delivery system of the present invention;

FIG. 2 is an illustration of one embodiment of the method of delivery of targeted promotions of the present invention;

FIG. 3 is an illustration of one embodiment of the apparatus of the present invention; and

FIG. 4 illustrates the media engine of FIG. 3, in further detail.

### DETAILED DESCRIPTION OF THE PREFERRED EMBODIMENT

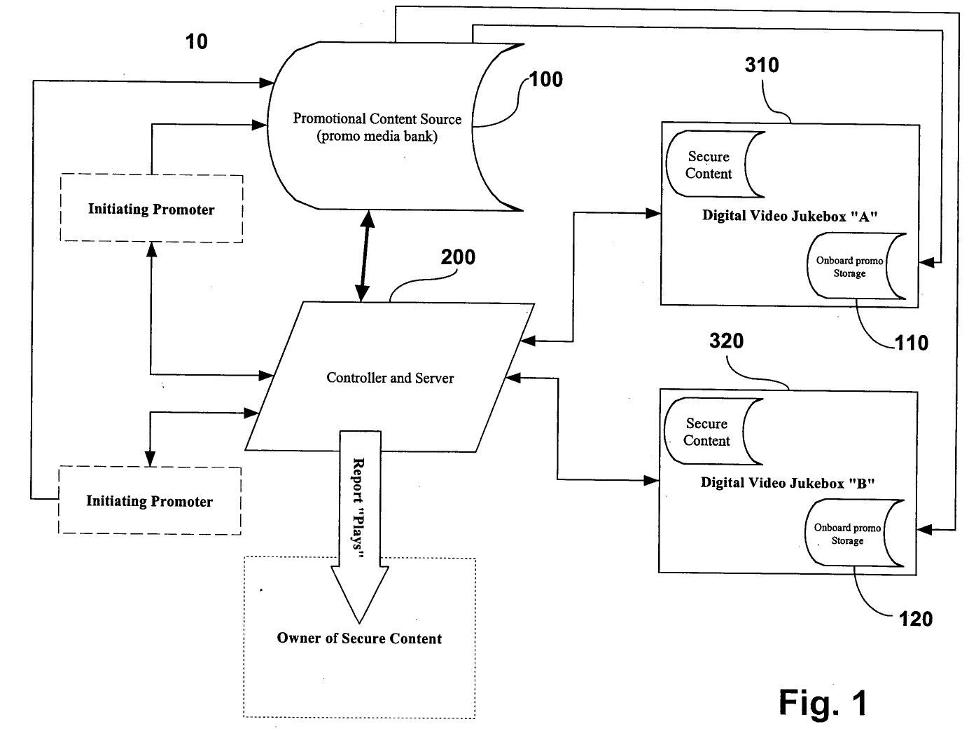

Reference is to be had to FIGS. 1, 2, and 3, in which identical reference numbers identify similar components.

In FIG. 1, a targeted promotion delivery system, denoted generally as 10 is shown having access to a source 100 of promotional content including, but not limited to, video, video with audio, animation, still images, and audio only elements. In a preferred embodiment a central control means 200, capable of serving instructions and content of various kinds to a plurality of audio-video apparatuses represented here by 310 and 320, is used to receive instructions from initiating promoters and to report to the suppliers of secure “paid” content of various kinds created by various artists. In one embodiment apparatuses 310 and 320 are Digital Video Jukebox include an interface with consumer-users for accepting payments and instructions to which apparatuses 310 and 320 respond by presenting the secure content requested—interspersed with promotional content in accordance with an embodiment of the present invention. Apparatuses 310 and 320 report actual presentations of both secure content and promotional content to Controller 200 permitting accurate accounting in the payment of royalties and the collection of promotional charges. The system 10 may also include a plurality of digital video entertainment devices, such as digital media engines that can operate without user interface. An example of this would be in a location such as “The Gap” where background music is played and video promotions are presented for entertainment and diversion purposes within the establishment. In this configuration, the digital media engine component is identical to the digital video jukebox (from a technical perspective) without an interactive user interface. In all of these configurations, the demographic information gathered from the consumer-user interactive devices is beneficial by all devices in the extended system.

Source 100 may have any portion of or its entire content enhanced or replaced in response to commands from either Controller 200 or an authorized initiating promoter, depending upon the business model paid for in the subject installation of System 10. Source 100 may further respond to requests from either apparatus 310 or apparatus 320, which apparatuses may each independently receive instructions through Controller 200 to present promotional content not available in their respective onboard promo storage means 110 and 120. Storage means 110 and 120 may further each add to or substitute new promotional content for any portion of their onboard promotional content in accordance with instructions received through Controller 200.

In a preferred embodiment control over how promotional content is interspersed with the secure content requested by consumer-users resides with Controller 200 permitting the Operators of system 10 to monitor presentation records for maintenance purposes as well as to change the rules periodically respecting the permitted associations between secure content and promotional content. In an alternate embodiment, particularly useful on low bandwidth installations, apparatuses 310 and 320 may operate in any one of their independent modes in each of which modes they have the means to locally control how promotional content is interspersed with the secure content requested by consumer-users. When apparatuses 310 and 320 operate in any one of their independent modes, Controller 200 operates as a relay merely forwarding instructions from a plurality of initiating promoters who compete for “air time” on any number of the audio-video apparatuses represented by apparatuses 310 and 320. Each of apparatus 310 and apparatus 320 may access Source 100 should the need arise, for any reason, to obtain new or refresh old or corrupt (data) content. Further if communication is temporarily lost between Controller 200 and either or both of apparatuses 310 and 320, then each of apparatuses 310 and 320 may optionally enter into a self-contained mode in which it delivers content in accordance with a ‘safe’ or preprogrammed set of instructions (maintained in ROM or other storage mechanism in which data can survive without power) while archiving its presentations for reporting to Controller 200 upon communication being restored”. The present embodiment of the method and apparatus are targeted towards the presentation of the advertising, however a certain aspect deals with the gathering and associating of the information. Conveniently, in the system, selected music and video is programmed to be played in certain orders and/or in association with other content. The scheduling is also designed to explicitly play the content in a non-synchronized or ‘disassociated’ manner. Preferrably with the system, people tend to select music in correlation with other music. For example, people that select Britney Spears are not likely to also select Johnny Cash. Further, people that select a lot of Johnny Cash and similar artists, in an establishment that has like clientel selecting similar music and purchasing beer is likely not a good location to advertise luxury cars. Conversely, this is likely a good establishment to advertise pick-up trucks.

Preferrably, the system has the opportunity to gather information into “bubbles’ of demographic data. For example, in a pay-for-play system, selections viewed and selected after a user has deposited money, and until such time that the credits for said money are consumed, those activities are valued in the context of an individual purchase stream and the information is containerized in a form that shows cross-correlation of the users activities in terms of similar music likes and desires while in a purchasing mode. In his example, the fact that the user purchased two Rolling stones selections then viewed three Britney Spears tracks but did not purchase may indicate a similarity in music tastes of the Britney Spears fans to the Rolling Stones fans however a missing particular type of Britney Spears music on the system. Should this type of correlation occur during multiple different user sessions it becomes valuable information as to what type of music to put on to the systems, where to promote the artists, and the type of audience tastes that may lead to similar alternate product promotions that would not normally be expected of an audience. In addition, the system tracks not only the selections that the user made on the system, but the selections that they viewed and in the order that they viewed them, whether in a purchasing session or not. Activity performed in the non-committed representation of the user. This information becomes valuable when collected and cross-correlated with the selections of other users, cross-referenced and analyzed in respect to locale, day, time, time of year, activities, promotions within the establishment, promotions presented by the system, market activities of the interested parties, etc. As the information is “rolled up’ from the users, to the venues, to the neighborhood, to the area of a city, to the city, etc, etc demographic profiles will appear.

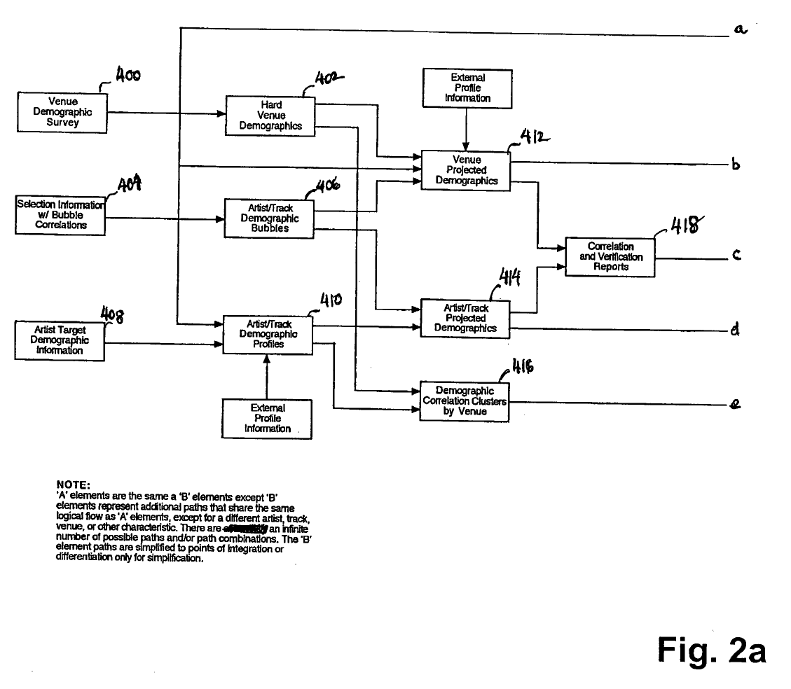

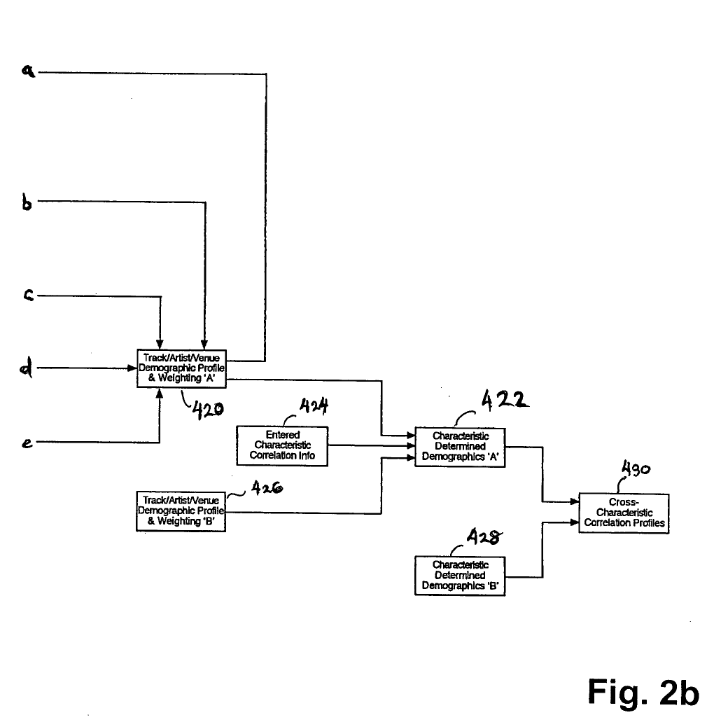

In FIG. 2, in a preferred embodiment, the method aspect of the present invention is the targeted promotion to an audience using at least one centrally controlled audio-video apparatus, having audience ranking data, comprising the steps: determining a desired audience for the subject promotion; selecting promotional content based on said determination; matching said desired audience to said audience ranking data; and transmitting instructions to at least one audio-video apparatus so matched for the purpose of causing said selected promotional content to be presented to at least one audience.

Referring to FIG. 2, there is illustrated a method of delivering targeted promotions of the present invention. A new system is initialized with venue demographic survey data as represented by a block 400. This data is augmented by data collected at the venue by the system as represented by6 a block 402. Content selections are tracked and correlated in bubbles as represented by a block 404. As selections are made this information is developed as artist/track demographic bubbles as represented by a block 406. Artist target demographic information is also supplied to the system as represented by a block 408. From this information external profile information and feedback within the system, artist/track demographic profiles are developed as represented by a block 410. Venue projected demographics as represented by a block 412 are developed from external profile information, the hand venue demographics 402, artist/track demographic bubbles 406 and system feedback. Similarly artist/track projected demographics 414 and demographic correlation clusters by venue 416 are derived from 406 and 410 and 402 and 410, respectively. Outputs from 412 and 414 are used to derive correlation and verification reports as represented by a block 418.

In FIG. 2a, a track/artist venue demographic profile and weighting A block 420, access input from blocks 412, 418, 414, and 416 and provide the system feedback mentioned above and in put to a block 422 characteristic determined demographics A, that also accepts input from blocks 424 and 426. Output of a parallel block 428 for “B” is confirmed with 422 to provide cross-characteristic correlation profiles.

In conjunction with FIG. 2, a description is provided of the scheduling mechanism of the overall system and how determined and derived demographic information is extracted from the system to aid in the system's ability to self-modify the content deployed to the individual media consoles.

The concepts for how the system derives information and uses it pertains to the music and music/video content and its use by the clientele of the venue are also described. The system builds demographic profiles by weighing several factors, each determined by the type of content going into the system and the type of results desired as an output. These profiles are used to recommend and ultimately auto-select new content for the system, the content including, for example, audio tracks, music videos, and promotional content.

There are basic definitions required to understand the logistics of the intelligent content classification and selection process.

Venue Surveyed Demographics—This is demographic information garnered through direct query and analysis for example question and answer interviews, questionnaires, direct research, onsite inspection, and third party demographic information. This type of information is regarded with a considerable amount of weight when the venue first comes online, and it is modified as actual demographic information is gathered to ultimately become Venue Projected Demographics.

Venue Projected Demographics—This is demographic information garnered through analysis of the preferred content chosen for play in a specific venue for example the times of the day that the said content is selected, day of the week the content is selected, and times of year the content is selected. As a venue operates over time, the strength of this demographic information begins to grow and patterns develop. This information is weighed on various scales including Content Projected Demographics for the entire onsite library to determine the actual demographic profile of the venue.

Characteristic Projected Demographics—This is demographic information garnered through a weighed average calculation of demographic information garnered from other venues, optionally with similar demographic makeup, within characteristic proximity. The primary feedback information is weighed strongly and in conjunction with the Venue Projected Demographics. For example, if a venue has relatively light demographic weight in the Vneue Projected Demographics area because the amount of time that information had been gathered was small (ie: a new installation), the demographic information is regarded with less significance than an establishment with, for example, a year of demographic data that is relatively consistent and predicatable. Within the desired characteristic the value of all venues within the area are weighted to determine the Characteristic Projected Demographics. A typical example of a characteristic used in this scenario would be the physical region of the media engine.

Content Surveyed Demographic—This is the original demographic profile for a content, element as provided by the content supplier.

Content Projected Demographic—This demographic information is the result of the analysis preformed on the content selected across venues to determine the actual ranking and demographic profile of said content. One way of calculating the proximate demographic categorization of a content entry is to determine the type of content that said content is selected in conjunction with. The demographic information of the associated content weighs on the factor values of the content under evaluation. For example given the assumption that artist “X” has a demographic of 30-45 year old males with income between 60,000 and 75,000 per year, living in an upper-middle class area, and making selections between 5:00 and 7:00 pm, and this demographic information has a strong weight factor, then if artist “Y” is selected in conjunction with the artist “X”, and this pattern appears often, it begins to weigh artist “Y”, and more so the selected track towards the same demographic profile as artist “X”. Conversely, the demographic profile of artist “X” begins to lean towards the demographics of artist “Y” as well. To counter this, a one-to-one profiling is not done rather the entire transactional “bubble” is gathered up and weighted across all selections within the bubble, and that overall weight determines the direction of bias.

Demographic Weight—The demographic weight of a content element is determined by many factors as determined by the content providers including but not limited to the frequency that the content is selected, by whom the content is selected, and where it is selected. The greater the consistent demographic history a content element has, the greater its demographic weight. Inconsistency, inexperience, and light selection activity work to reduce or diminish the demographic weight.

Now, referring to FIG. 2a, upon initialization the content library is loaded into the system and prepared for delivery to the Media Engines in the venues. The Content Surveyed Demographics for individual content element, as supplied by the content supplier, is entered in correlation with the content itself.

When a venue is engaged, as much demographic information about the venue as is desired and available is gathered and entered into the system. This data is the Venue Surveyed Demographics and becomes the base representation of the venue. The information is used in conjunction with information from venues with a similar demographic profile to make the initial determination as to the content to be provided to the venue. Alternately, the venue could request specific entries for their library as all selections initially enter the venue as un-weighed.

As the venue begins to operate, selections are made into the venue's console and are uploaded to the main system. As time passes, the system will calculate the Content Projected Demographic information for the venue to make appropriate recommendations as to the content to be loaded into the venue, and to evaluate the Venue Projected Demographics. This information is then used to determine the appropriate content for the venue and to aid in the generation of the Characteristic Projected Demographics.

As a venue's demographic profile evolves, the determination as to the recommended content also evolves. New content is loaded to the venue and content that falls outside the demographic is removed, excepting where said content has popularity. It is expected that this would not occur as the continued selection of said content elements would tend to reclassify the content to be in line with this demographic.

This process continues to develop into perpetuity as the venue, the region it is in, the clientele that frequent the venue, and other applicable characteristics evolve.

Each venue, content element, and priority characteristic are mapped on to a multidimensional hypercube, said mapping constantly changing to reflect the actual state of the item. These hypercubes are statistically compared and contrasted to evaluate patterns of performance within the overall system as well as to any level of granularity right down to any individual characteristic.

The venue demographic is determined by calculating a number of factors to create an overview of the type of clientele that frequent the venue, the days of the week that they visit the venue, the typical times per day that they are in attendance.

Upon installation, the Venue surveyed Demographics 400 are entered into the overall system. This type of information may include average age, beverage preference, food preference, male/female ratios, etc. This information is used in conjunction with the Content Projected Demographics and Characteristic Projected Demographics in an attempt to determine the actual demographic makeup of the venue. This resultant information is used by the system to determine the appropriate content of the venue.

To determine the best venues for a targeted promotional campaign, the supplier of the promotion would present information to qualify the targeted audience. The higher the resolution of this information, the greater the accuracy of the audience targeted.

Given sufficient information to evaluate a target audience including but not limited to age group, region, sex, etc. the content can be matched against the most appropriate demographic group. The content would be loaded to the system and the system can provide the matching that the user can (optionally) override. Upon release of the content for distribution, the system will prepare and distribute the content to the selected systems.

This information is mapped on to an artificial hypercube that is statistically matched to the system's hypercube matrix to form the best determinations for deployment of the content in respect to the desired input characteristics.

In an alternate embodiment of the method aspect of the present invention control is not central yet the same basic Rule Sets apply to the targeted promotion to an audience using at least one self identifying audio-video apparatus, having audience ranking data, comprising the steps: determining a desired audience for the subject promotion; transmitting desired audience instructions to at least one audio-video apparatus; selecting promotional content based on said determination; matching said desired audience to said audience ranking data; and presenting said selected promotional content to at least one audience using each audio-video apparatus so matched.

In the music industry, there is a license called a synchronization license that says if you play one piece of video with a piece of audio, the person that put those two pieces together must pay a fee. This license however applies to items that are mastered together and does not apply where a video is being played on one device (your home TV without volume), while audio is played on a different device (your home stereo). This is a situation where the audio and video were not intentionally scheduled together or synchronized and the results are therefore exempt. As described above, the present system creates non-synchronized media playback so that creating a situation where a given piece of video content and a given piece of audio content being played at the same time is astronomically high, except where said synchronization is desirable (i.e.: a music video).

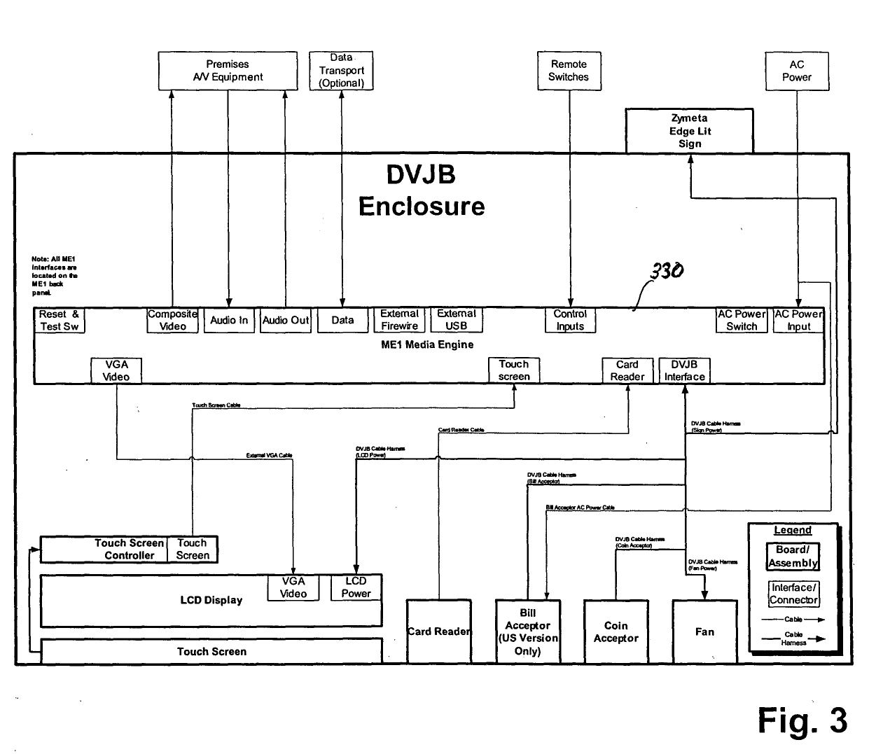

In FIG. 3, the audio-video apparatuses, represented by apparatuses 310 and 320, of a targeted promotion delivery system, are shown. The digital video jukebox (DVJB) of FIG. 3 includes a media engine 330 having a plurality of input/output devices and interfaces. For example composite order out, audio in/out, data communications, control input, VGA video out, touch screen input, card, bill, coin inputs.

In a preferred embodiment said audio-video apparatuses may optionally enter a mode that is truly random in which the visible and audible elements delivering secure content operate in complete isolation from the visible and audible elements delivering promotional content (akin to 2 separate television devices located in proximity to one another, but displaying independent channels) for the purpose of satisfying the license requirements of the suppliers of secure content.

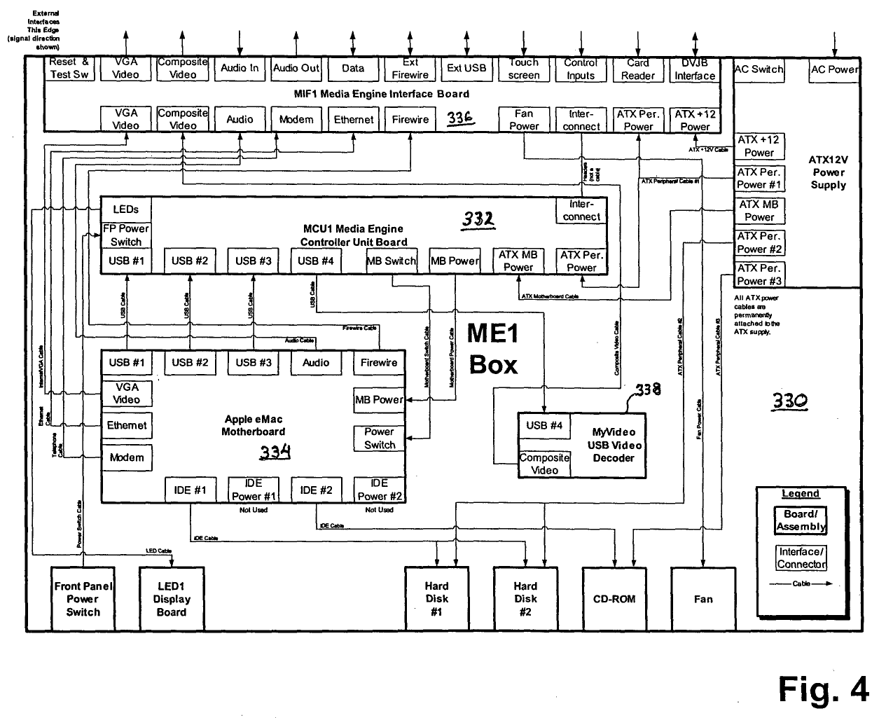

Referring to FIG. 4, there is illustrated in a functional block diagram the media engine 330 of FIG. 3. The media engine 330 includes a controller 332, a computer mother board 334, an interface board 336 and a video decoder 338.

By way of example, but not in limitation, an airline might at the last minute wish to fill some of the empty seats on a flight from Calgary to Las Vegas using a combination of deep discounts and other incentives. The traditional means for advertising such time limited opportunities are all of: too slow to respond to a “same day” decision to deep discount, too broadly distributed to efficiently deliver the related promotional message to actual buyer, and too rigidly structured to be effective in transforming that message into sales on such short notice. The airline may take advantage of the system of the present invention to target the patrons of travel agencies as well as gambling and drinking establishments. In Calgary the airline could specify the Silver Dollar Casino for example. Within Alberta the airline to specify all drinking establishments classified as patronized by a particular class of mobile, 25-35 year old patrons who are likely to be able to and wish to respond to deep discount opportunities. Once the installed venues have been specified the airline determines the time period of and budget for the focussed marketing strike. In a countdown manner the campaign may be presented by all apparatus on the system located within driving distance radius less 90 minutes from the Calgary airport from where the subject flight respecting which the promotion is being launched departs. To facilitate patrons making purchasing decisions the airline could inject or otherwise include clips of teaser content (e.g. movie clips from Viva Las Vegas by MGM) in its promotional content data upon agreement to pay appropriate royalties or other forms of compensation. As flight time approaches the number of apparatus presenting the special campaign decreases since even if the patrons decide to join the flight they will be too late to catch the plane after clearing security. To facilitate making the purchase decision, the airline may co-promote complementary services using the same technologies. For instance, once payment and reservation have been confirmed the patron may elect to mobilize enabling services such as “Temp Workers”, flowers, gifts, and notice services to their Employer where necessary to call in due to missing work for a few days to take advantage of the short notice travel opportunity of this example. The airline may even (like radio stations do from time to time) offer these services along with luggage and parking or taxi services as an incentive bundle co-sponsored by others. Upon confirmation of payment, tracking services may be initiated to permit the patron to arrange such details in flight rather than using time needed to get to the airport safely. For normal term purchase decisions facilitated through the present invention payment and reservation means through the same apparatus used to deliver the promotional content permit detailed tracking of consumption preferences and patterns that permit a continual refinement of the presentations made to the subject venue and its patrons. Completing the travel scenario, once in flight the post-sale co-sale consumption tracking and data sharing may continue with the airline making value added data (personal or anonymous according to the individual patron's wishes) available to the system or just to the co-promoter according to the business model selected by the initiating promoter. By sending a focussed custom message to reach a select group of willing buyers in a timely manner, the present invention converts opportunities into sales at a higher rate than the more rigid traditional means of targeted promotion.

Although the disclosure describes and illustrates various embodiments of the invention, it is to be understood that the invention is not limited to these particular embodiments. Many variations and modifications will now occur to those skilled in the art of electronic promotion. For full definition of the scope of the invention, reference is to be made to the appended claims.

We claim:

1. A method of targeted promotion to an audience using at least one centrally controlled audio-video apparatus, having audience ranking data, comprising the steps:
determining a desired audience for the subject promotion;
selecting promotional content based on said determination;
matching said desired audience to said audience ranking data; and
transmitting instructions to at least one audio-video apparatus so matched for the purpose of causing said selected promotional content to be presented to at least one audience.

2. A method of targeted promotion to an audience using at least one self identifying audio-video apparatus, having audience ranking data, comprising the steps:
determining a desired audience for the subject promotion;
transmitting desired audience instructions to at least one audio-video apparatus;
selecting promotional content based on said determination;
matching said desired audience to said audience ranking data; and
presenting said selected promotional content to at least one audience using each audio-video apparatus so matched.

3. The method as claimed in claim 2 wherein the step of determining a desired audience for the subject promotion further comprises consideration of one or more factors selected from the group of:
date,
day of week,
time of day,
time of year,
special events and activities,
demographic data of region,
demographic data of venue location,
user feedback,
statistical data gathered from third parties.

4. The method as claimed in claim 3 wherein said promotional content is presented as one of in addition to and interspersed with secure content.

5. The method as claimed in claim 4 wherein the step of selecting promotional content further comprises consideration of one or more factors selected from the group of:
secure content presented concurrently,
pending user selections of secure content,
recent presentations or promotional content,
maximum presentations permitted per unit time,
desired blends (tempos)
absolute bars respecting association
compatible artists and preferred associations,
pre-existing consent or permitted association license grants,
queue jumping or priority play acceleration fees paid by initiating promoter,
initiating promoter preferred time slot bidding results,
venue and network operator promotions, and
initiating promoter account status.

6. The method as claimed in claim 5 further comprising the step of pre-classifying said promotional content for the purpose of facilitating said matching step, said pre-classification including reference to an external classification resource.

7. The method as claimed in claim 6 further comprising the step of pre-classifying said secure content for the purpose of matching same with promotional content to be associated therewith, said pre-classification including reference to an external classification resource.

8. The method as claimed in claim 7 further comprising the step of refining the selection of promotional content based on data respecting the presence of specific current patrons or of the cross-section (averaged) of a class of patrons in the subject venue.

9. The method as claimed in claim 8 further comprising the step of providing access by external parties, including but not limited to initiating promoters, to an inventory of promotional content that has been created, converted, or otherwise supplied and uploaded to a source for the purposes of being altered externally and also being used to alter the promotional content stored on or presented through said audio-video apparatus.

10. The method as claimed in claim 9 further comprising the step of providing access by external parties, including but not limited to initiating promoters, to inject promotional content on short notice to a current presentation by said audio-video apparatus for the purpose of enhancing or supplementing at least one scheduled promotional presentation.

11. The method as claimed in claim 10 further comprising the step of permitting consumer-users to access said apparatus by alternative input means selected from physical touch screen interface, voice commands, wireless hand held devices, PDAs, SmartCards for the purposes of selection and payment.

12. The method as claimed in claim 11 further comprising the step of permitting purchases to be made by consumer-users through said audio-video apparatus and tracking said purchases for the purpose of detecting (or identifying) and cross-tracking consumption patterns.

13. The method as claimed in claim 12 further comprising the step of determining and tracking the conversion rate achieved by presenting each said promotional content to sales and feeding back the results for the purpose of supporting the evolutionary behaviour of said system permitting the refinement of the “association rules” that govern which secure content to associate each promotional content with for the purpose of improving the conversion rate, including but not limited to free plays of “clips” of secure content during “idle” mode when said apparatus awaits instructions from consumer-users making selections.

14. A audio-video apparatus comprises a digital video jukebox having:
storage and retrieval means for handling data representing promotional content associated with audience ranking data;
storage and retrieval means for handling data representing secure content;
interface means for accepting and responding to user selections respecting secure content;
at least one presentation means having elements that are visible or audible to or receivable by said audience;
means for preventing the presentation of specified promotional content during the presentation of specified secure content;
means for receiving instructions; and
means for presenting promotional content.

15. The audio-video apparatus as claimed in claim 14 further comprising means for matching said desired audience to said audience ranking data.

16. The audio-video apparatus as claimed in claim 15 further comprising means for selecting promotional content based on determination of a desired audience.

17. The audio-video apparatus as claimed in claim 16 further comprising means for tracking said user selections for the purpose of refining said audience ranking data.

18. The audio-video apparatus as claimed in claim 17 further comprising means for the local tracking, processing and archiving of system usage and presentations made, for the purpose of developing a database useful in detecting consumption patterns in addition to accounting functions.

19. The audio-video apparatus as claimed in claim 18 further comprising means for the transfer of promotional content (and reporting data) between said apparatus and at least one controller or server.

20. The audio-video apparatus as claimed in claim 19 further comprising means for the instant reconfigurability of promotional content having override codes permitting an external party to inject promotional content on short notice to a current presentation by said apparatus for the purpose of enhancing or supplementing at least one scheduled promotional presentation.

21. The audio-video apparatus as claimed in claim 20 further comprising means for permitting consumer-users to access said apparatus by alternative input means including, but not limited to, physical touch screen interface, voice commands, PDAs, other wireless hand held devices, SmartCards for the purposes of selection and payment.

22. The audio-video apparatus as claimed in claim 21 further comprising encryption or other secure means for the transfer of secure content into said apparatus or from said apparatus to external devices or media for distribution in isolation or as part of a compilation.

23. A system for centrally controlled targeted promotion, for the use of an initiating promoter wishing to present promotional content to a desired audience respecting which audience said promoter has determination data, comprising:
at least one source of promotional content;
means for said initiating promoter to supply desired audience determination data;
means for selecting promotional content based on matching in light of said determination data;
at least one audio-video apparatus, having audience ranking data, for presenting promotional content to said desired audience; and
Controller means for transmitting instructions to said audio-video apparatus, together with Server means for transferring said promotional content to said audio-video apparatus for the purpose of causing said selected promotional content to be presented to at least one audience at a desired time.

24. The system as claimed in claim 23 further wherein there are means to store and retrieve promotional content onboard said audio-video apparatus.

25. The system as claimed in claim 24 further wherein there are means to securely store and retrieve secure content onboard said audio-video apparatus.

26. The system as claimed in claim 25 further wherein there are means for an initiating promoter to supply or reconfigure said promotional content by substitution or supplementation.

27. The system as claimed in claim 26 further wherein there are means to accept payment from consumer-users, for the selection of secure content to be presented, or for the purchase of goods and services based on said promotional content using an interface to said audio-video apparatus.

28. The system as claimed in claim 27 further wherein there are means to track the presentation of promotional content or secure content for accounting and statistical purposes.
